(19) United States
(12) Patent Application Publication
(10) Pub. No.: US 2023/0032139 A1
(43) Pub. Date: Feb. 2, 2023

(54) HIGH SPEED TRUST EVALUATION FOR FILE ACTIVITY

(71) Applicant: RackTop Systems, Inc., Fulton, MD (US)

(72) Inventors: Jonathan Halstuch, Fulton, MD (US); Eric Bednash, Fulton, MD (US)

(21) Appl. No.: 17/390,412

(22) Filed: Jul. 30, 2021

(51) Int. Cl. H04L 29/06; G06F 21/62; G06F 9/54

(52) U.S. Cl. CPC H04L 63/1433; H04L 63/20; G06F 21/6218; H04L 63/08; G06F 9/547; H04L 63/1491

(57) ABSTRACT

Methods and systems for trust evaluation of network activities are provided. An example method commences with receiving, from a user, a request to access at least one file on a network. The method further includes authenticating the user using a multi-factor authentication method. The method continues with selectively granting the user a credentialed access to the at least one file based on the authentication. The method further includes analyzing, based on a security policy, at least one activity of the user. The security policy includes at least one trigger event and at least one mitigating action. The method further includes triggering re-authentication of the user in response to determining, based on the analysis, that the at least one trigger event has occurred. The method then continues with selectively performing the at least one mitigation action based on results of the re-authentication.

### TECHNICAL FIELD

This disclosure generally relates to data processing and, more particularly, to high speed trust evaluation for file activity.

### BACKGROUND

A human adversary or malware can gain access to a machine that has credentialed access to files over the network. For example, a user may be logged in and the malware running on a user device may use the logged-in state of the user to launch a cyber operation to steal, modify, or delete files against the intentions of the user or the organization's best interest. Multi-factor authentication for the login to a machine can prevents attackers from gaining access to the machine. However, once the user logs in, the attackers can use malware residing on the machine to leverage the user credentials to perform nefarious activities against files and data. Additionally, once the user logs in, there is nothing to prevent the user from malicious activities.

Conventional file protocols, file sharing protocols, do not provide any means of re-authenticating the user once the user has been authenticated. The conventional security protocols or security systems provide simple identity and access assessments for authenticating users, but do not analyze the behavior, intent, or accessed content nor do they make assertions of whether that activity should occur regardless of the user's ability to access such data.

### SUMMARY

This section introduces a selection of concepts in a simplified form that are further described in the Detailed Description section, below. This summary does not identify key or essential features of the claimed subject matter and is not intended to be an aid in determining the scope of the claimed subject matter.

This present disclosure is directed to systems and methods for trust evaluation of network activities. According to an example embodiment, a system for trust evaluation of network activities is provided. The system may include an active defense unit, a real-time assessing unit, an identity management unit, and an incident management unit. The active defense unit may be configured to receive, from a user, a request to access at least one file on a network. The active defense unit may authenticate the user using a multi-factor authentication method and, based on the authentication, selectively grant the user a credentialed access to the at least one file. The real-time assessing unit may be configured to analyze, based on a security policy, at least one activity of the user. The security policy may include at least one trigger event and at least one mitigating action. The identity management unit may be configured to trigger re-authentication of the user in response to determining, based on the analysis, that the at least one trigger event has occurred. The incident management unit may be configured to selectively perform the at least one mitigation action based on results of the re-authentication.

According to another example embodiment, a method for trust evaluation of network activities is provided. The method may commence with receiving, from a user, a request to access at least one file on a network. The method may further include authenticating the user using a multi-factor authentication method. The method may further include selectively granting the user a credentialed access to the at least one file based on the authentication. The method may continue with analyzing, based on a security policy, at least one activity of the user. The security policy may include at least one trigger event and at least one mitigating action. The method may further include triggering a re-authentication of the user in response to determining, based on the analysis, that the at least one trigger event has occurred. The method may continue with selectively performing the at least one mitigation action based on results of the re-authentication.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram showing an example environment in which a system and a method for trust evaluation of network activities can be implemented.

FIG. 2 is a block diagram showing a client device used by a user for accessing a network and performing network activities, according to an example embodiment.

FIG. 3 is a block diagram illustrating an example system for trust evaluation of network activities, according to an example embodiment.

FIG. 4 is a block diagram illustrating an operation of a system for trust evaluation of network activities, according to an example embodiment.

FIG. 5 is a flow chart showing a method for trust evaluation of network activities, according to an example embodiment.

FIG. 6 is a high-level block diagram illustrating an example computer system, within which a set of instructions for causing the machine to perform any one or more of the methodologies discussed herein can be executed.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and operational changes can be made without departing from the scope of what is claimed. The following detailed description is, therefore, not to be taken in a limiting sense, and the scope is defined by the appended claims and their equivalents.

The present disclosure relates to systems and methods for trust evaluation of network activities. The systems and methods focus on stopping nefarious activities that would normally go undetected or take too long to detect.

In one example embodiment, a user may send a request to access a file on a network. The system disclosed herein may receive the request and, in response to the request, authenticate the user using a multi-factor authentication method. Various multi-factor authentication methods may be used for the multi-factor authentication. Once the user is authenticated, the system can grant the user a credentialed access to files.

After the user is granted the credentialed access, activities of the user with respect to the files on the network may be continuously monitored and analyzed based on a security policy. The security policy may include trigger events and mitigating actions to be taken in response to detection of the trigger events. The trigger events may include any activity of the user determined to be suspicious or unusual.

When it is determined, based on the analysis of the activity of the user, that a trigger event has occurred, the system can trigger re-authentication of the user. Based on results of the re-authentication, a mitigation action can be performed, if needed.

The system may use multiple pieces of information related to the activity of the user on the network to detect a trigger event and initiate re-authentication of the user to ensure that the behavior of the user is intentional and authorized and that the user has been previously granted the credentialed access.

The security policy may be set by an organization and provide guidelines for expected user activities with respect to various files. Activities that do not conform with the expected activities may trigger a re-authentication event. Access to files can be suspended immediately until the user re-authenticates or suspended when the user fails to re-authenticate within a certain period of time. In other words, in one example embodiment, the user's access is immediately suspended until they successfully re-authenticate. In another example embodiment, the user can continue accessing files for a certain period pending successful re-authentication within that period of time. The access may be suspended for a user account associated with the user or a specific client Internet Protocol (IP) address of a client device the user used to log in. If the access is suspended, the user's privileges can be limited.

By allowing the system to force re-authentication for a specific user, IP address, or all users, the network (e.g., a network of an organization) can be quickly locked down to prevent a potential attack or breach of security. For instance, if the system discovers that the network is under attack of an adversary, e.g., in case of ransomware, the system can force re-authentication of all users. The system may also provide an indication, to a security team, of activities that should be investigated, e.g., by looking at activities of the users that failed to re-authenticate.

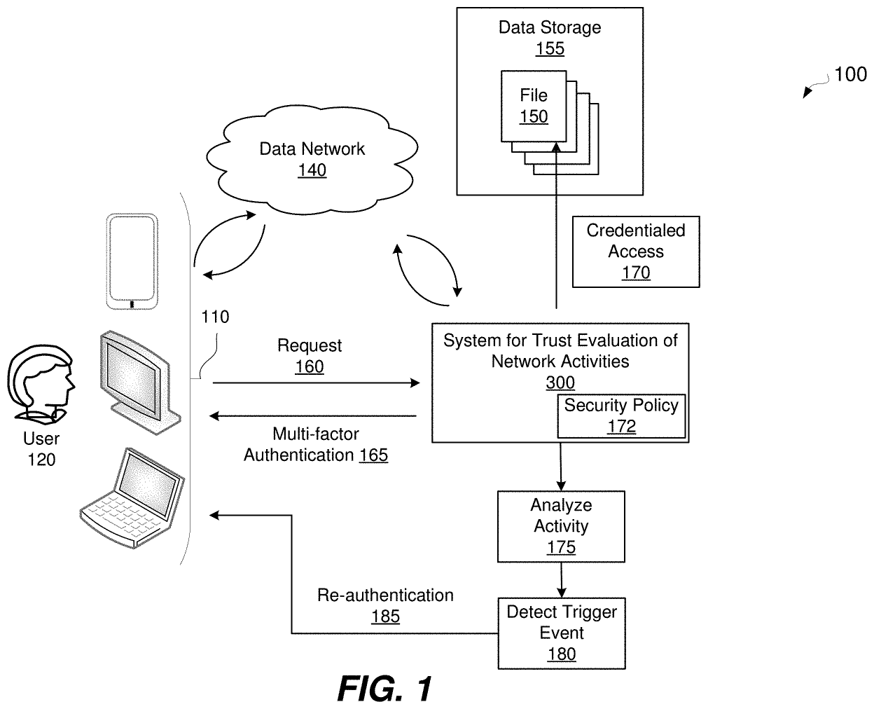

Referring now to the drawings, FIG. 1 shows an example environment 100, in which a system and a method for trust evaluation of network activities can be implemented. The environment 100 may include a client device 110, a user 120 associated with the client device 110, a system 300 for trust evaluation of network activities, and a data network 140.

The user 120 may be associated with an organization (not shown). The organization may have a data storage 155 for storing a plurality of files 150 associated with the organization. The organization may connect the system 300 to the network associated with the organization to provide trust evaluation of network activities of users in the network. The system 300 may be responsible for authenticating the users to access to one or files 150 of the organization.

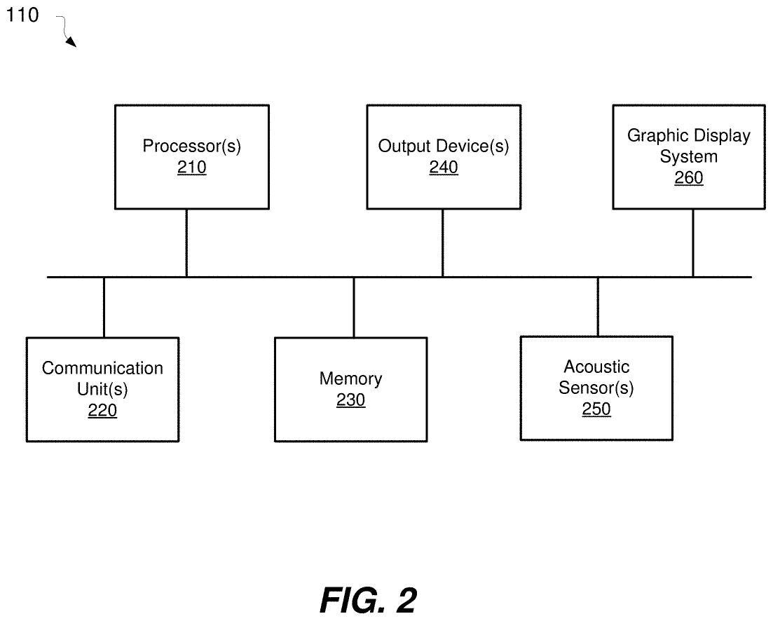

The user 120 may request to access one or more files 150 stored in the data storage 155. Specifically, the user 120 may use the client device 110 to send a request 160 to access the one or more files 150. The client device 110 may include, but is not limited to, a laptop computer, a desktop computer, a tablet computer, a phablet, a smart phone, a personal digital assistant, a media player, a mobile telephone, a smart television set, in-vehicle infotainment system, a smart home device, and the like. An example client device 110 is described in detail in FIG. 2.

The system 300 may receive the request 160 and, in response to the request 160, may authenticate the user 120 using a multi-factor authentication 165. In the course of the multi-factor authentication 165, the user 120 is granted access to the one or more files 150 only after the user 120 successfully presents two or more pieces of evidence (or factors) to an authentication mechanism associated with the system 300. In an example embodiment, the user 120 may use one or more of the client devices 110 associated with the user to pass the multi-factor authentication 165. Any methods of multi-factor authentication may be used. Based on successful authentication, the user 120 may be granted a credentialed access 170 to the one or more files 150.

After granting the credentialed access 170, the system 300 may analyze activity of the user 120 based on a predetermined security policy 172, as shown in block 175. The activity of the user 120 may include actions performed by the user 120 with respect to the files 150, actions performed by the user 120 via the client device 120, actions performed by the user 120 with respect to applications associated with the system 300, actions performed by the user in the data network 140, and so forth.

Based on the analysis of the activity of the user 120, the system 300 may determine that a trigger event has occurred, as shown in block 180. The types of activity that are determined to be trigger events may be predetermined in the security policy 172. Upon detection of the trigger event, the system 300 may trigger a re-authentication 185 of the user 120.

The re-authentication 185 may be performed according to a predetermined re-authentication protocol. The predetermined re-authentication protocol may require the user 120 to perform self-service actions, such as respond to email challenge questions or respond to web link challenge questions. In an example embodiment, the predetermined re-authentication protocol may involve a third party participating in the re-authentication 185 (e.g., when a third party validation officer is notified about the re-authentication 185 and contacts the user 120 by approved means to challenge the user 120).

In an example embodiment, communication between the client device 110, the system 300, and the data storage 155 may be provided using the data network 140. The data network 140 can refer to any wired, wireless, or optical networks including, for example, the Internet, intranet, local area network (LAN), Personal Area Network (PAN), Wide Area Network (WAN), Virtual Private Network (VPN), cellular phone networks (e.g., Global System for Mobile (GSM) communications network), Wi-Fi™ network, packet switching communications network, circuit switching communications network), Bluetooth™ radio, Ethernet network, an IEEE 802.11-based radio frequency network, a Frame Relay network, IP communications network, or any other data communication network utilizing physical layers, link layer capability, or network layers to carry data packets, or any combinations of the above-listed data networks. In some embodiments, the data network 140 includes a corporate network, data center network, service provider network, mobile operator network, or any combinations thereof.

FIG. 2 is a block diagram showing a client device 110 used by a user, according to an example embodiment. FIG. 2 provides details of the client device 110 of FIG. 1. In the illustrated embodiment, the client device 110 may include one or more processor(s) 210, one or more communication unit(s) 220, a memory 230, one or more output device(s) 240, one or more acoustic sensor(s) 250, and a graphic display system 260. In other embodiments, the client device 110 may include additional or other components necessary for operations of client device 110. Similarly, in certain embodiments, the client device 110 may include fewer components that perform functions similar or equivalent to those depicted in FIG. 2.

In various embodiments, the processors 210 include hardware and/or software, which is operable to execute instructions stored in the memory 230. The processors 210 may include general purpose processors, video processors, audio processing systems, and so forth.

In various embodiments, the communication unit(s) 220 can be configured to communicate with a network such as the Internet, WAN, LAN, cellular network, and so forth, to receive audio and/or video data of media streams. The received data (e.g., the data associated with one or more files accessed by the user) may be received by the communication unit(s) 220 and then forwarded to the processor(s) 210. The processor(s) 210 may analyze the received data and provide the data to the graphic display system 260 to be presented to the user.

The acoustic sensor(s) 250 can include one or more microphones. The processor(s) 210 can be configured to receive acoustic signals from an acoustic source, for example, the user 120, via acoustic sensor(s) 250, and process the acoustic signals. The acoustic sensor(s) 250 can be spaced a distance apart to allow the processor(s) 210 to perform a noise and/or echo reduction in received acoustic signals.

In some embodiments, the output device(s) 240 may include any device which provides an audio output to a listener (for example, the user 120). The output device(s) 240 may include one or more speaker(s), an earpiece of a headset, a handset, and the like.

The acoustic sensor(s) 250 and the output device(s) 240 may be used, for example, during the re-authentication when the user is required to record an audio or a video and provide the audio or the video to the system 300 shown in FIG. 1.

In various embodiments, the graphic display system 260 can be configured to provide a graphic user interface (GUI). In some embodiments, a touch screen associated with the graphic display system 260 can be utilized to receive an input from a user.

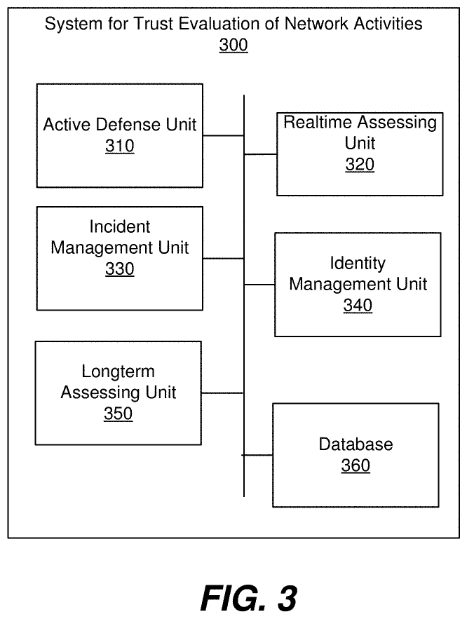

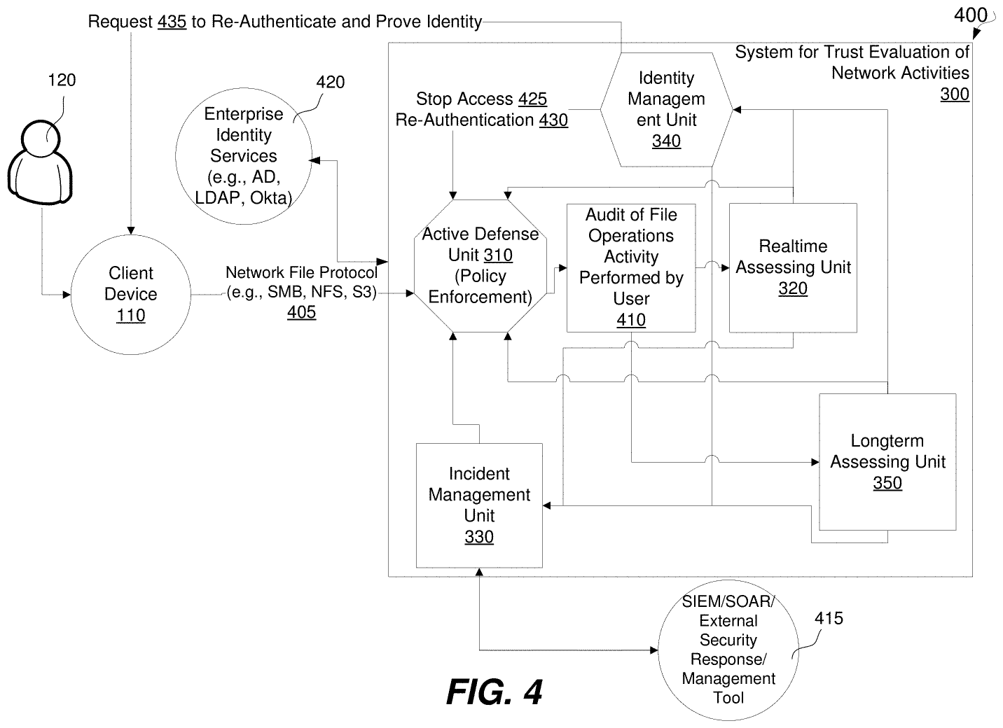

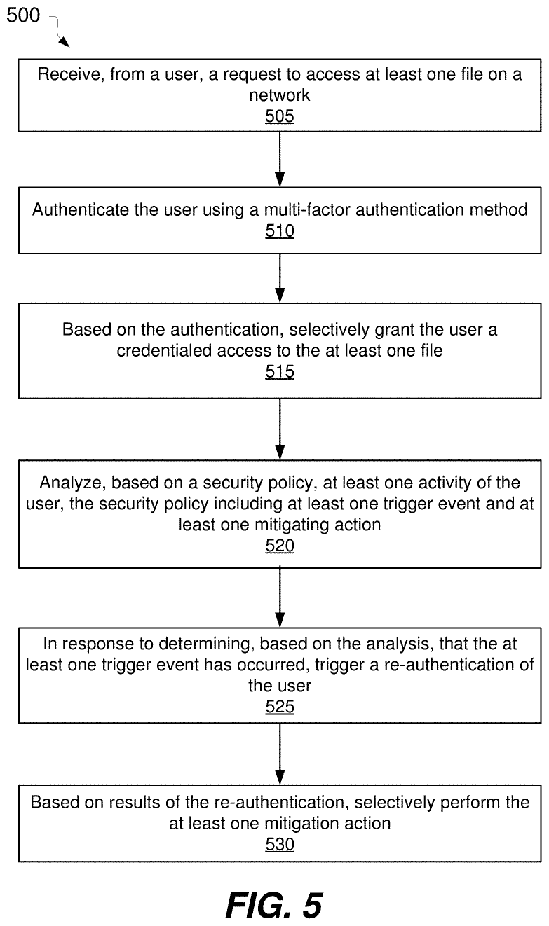

FIG. 3 is a block diagram illustrating an example system 300 for trust evaluation of network activities, according to an example embodiment. The system 300 may include an active defense unit 310, a real-time assessing unit 320, an incident management unit 330, an identity management unit 340, a long-term assessing unit 350, and a database 360. The functionalities and operations performed by the elements of the system 300 are described in detail with reference to FIGS. 4 and 5.

In an example embodiment, each of the active defense unit 310, the real-time assessing unit 320, the incident management unit 330, the identity management unit 340, and the long-term assessing unit 350 may be implemented in a form of one or more processors in communication with the database 360. The one or more processors may be configured to execute units 310-350, and/or other modules by software, hardware, firmware, some combination of software, hardware, and/or firmware, and/or other mechanisms for configuring processing capabilities on one or more processors. As used herein, the term “unit” may refer to any component or set of components that perform the functionality attributed to the unit. This may include one or more physical processors during execution of processor readable instructions, the processor readable instructions, circuitry, hardware, storage media, or any other components.

FIG. 4 is a block diagram 400 illustrating an operation of a system 300 for trust evaluation of network activities, according to an example embodiment. The active defense unit 310 may have an active defense capability to stop a specific user or an IP address of a client device from accessing files on the network. The active defense unit 310 may act as a policy enforcement point and may apply a predetermined security policy to granting the client device 110 with an access to files in the network. Specifically, the active defense unit 310 may be configured to receive, from a user 120, a request to access at least one file on a network. The client 120 may send the request via a client device 110. In an example embodiment, the request may be sent via a network file protocol 405. The network file protocol 405 may include Server Message Block (SMB) protocol, Network File System (NFS) protocol, Amazon Simple Storage Service (S3) protocol, and so forth. In an example embodiment, the request may be associated with a user account of the user 110 and/or a client machine IP address (i.e., an IP address of the client device 110).

In response to the request, the active defense unit 310 may authenticate the user 120 using a multi-factor authentication method. Based on the multi-factor authentication, the active defense unit 310 may selectively grant the user 120 a credentialed access to the at least one file stored in the network. The credentialed access may be associated with one or more of the following: a user account associated with the user 110 and user credentials, an IP address of the client device 120, a group of users associated with the IP address, and so forth.

In some example embodiments, the system 300 may authenticate the user 120 using enterprise identity services 420, such as Active Directory (AD) service, Lightweight Directory Access Protocol (LDAP), Okta™ services, and so forth.

After the credentialed access is granted to the user 120, the real-time assessing unit 320 may analyze at least one activity of the user 120 in the network to which the credentialed access was granted. In an example embodiment, the analysis may include auditing file operations activity performed by the user 120, as shown in block 410.

The real-time assessing unit 320 and the long-term assessing unit 350 may include microservices and can exist on a local security platform associated with the network or as part of a distributed architecture. The real-time assessing unit 320 and the long-term assessing unit 350 may receive an audit log of the activity of the user with respect to one or more files, which includes but is not limited to file access patterns.

The analysis may be performed by using a behavior analysis engine and based on the security policy. The security policy may include at least one trigger event and at least one mitigating action. The real-time assessing unit 320 may determine, based on the analysis of the at least one activity of the user 120, that the at least one trigger event has occurred. In an example embodiment, the at least one trigger event may include one or more of the following: an access to share from a new IP address by the user (for first time by the user), an access to a folder for a first time and after a time period by the user, an access outside of defined normal working hours, a mass delete, a mass read, a mass copy, a total number of files accessed by the user, a file extension rename, an access to a designated sensitive folder, an access to a designated sensitive folder after a time period, an access to a designated sensitive file, an access by an administrative user, an access by an administrative group, a simultaneous access from multiple client devices with the same user account, an access to file shares for the first time after a defined period of inactivity defined by an organization, an excessive number of incorrectly entered passwords, and so forth.

The real-time assessing unit 320 and the long-term assessing unit 350 can be programed to initiate a predefined mitigation action based on predetermined conditions, i.e., based on detection of trigger events. Upon detecting the trigger event, the real-time assessing unit 320 or the long-term assessing unit 350 may open an incident (i.e., detection of the trigger event) and notify the identity management unit 340 to disable the user account, an IP address of the client device, or the user account and the IP address to access the files.

In response to determining that the at least one trigger event has occurred, the identity management unit 340 may trigger a re-authentication 430 of the user 120. The re-authentication may be triggered by sending, using one of the methods allowed by the organization, a request 430 to re-authenticate to the client device 110 in order to prove an identity of the user 120. For the time the re-authentication is in progress, the access to the at least one file and/or the access to other files in the network may be stopped for the user 120, as shown by step 425.

In an example embodiment, the identity management unit 340 may use a zero trust model and evaluate a trust associated with the user account or the IP address of the client device upon each action performed by the user in the network.

In an example embodiment, the triggering of the re-authentication includes sending a request to a data storage through an Application Programming Interface (API) to force the re-authentication, performing the re-authentication of users associated with an organization after a defined period at random, and so forth.

The re-authentication may be performed according to a predetermined re-authentication protocol. The predetermined re-authentication protocol may include one or more self-service user actions performed within a time window. The self-service user actions may include one or more of the following: responding to a Short Message Service (SMS) push notification, confirming information sent in an email to the user, or responding to an email to confirm the user account. The self-service user actions may further include responding to an email with need for the user to identify, in a list shown to the user, files recently accessed by the user, responding to an email challenge question, responding to a web link challenge question, and the like. In a further example embodiment, the predetermined re-authentication protocol may include involving one or more of third parties into the re-authentication. For example, a third party validation officer may be notified of the trigger event and may contact the user by an approved means to challenge the user. The third party actions may include, for example, requiring the user to record an audio or a video with a random phrase within a time period (e.g., within a short time window). The audio or the video may be reviewed by a third party for correctness. The third party actions may further include matching the video provided by the user with a picture of the user pre-stored in the system 300, forcing a challenge through a third party enterprise identity management system, and the like.

In an example embodiment, the system 300 may expose an external API to enable third party tools, such as a security orchestration, automation, and response (SOAR), to force any or all users to re-authenticate on demand.

If the user 120 successfully re-authenticates, the user 120 may be enabled to continue to access the files on the network. If the user 120 does not re-authenticate, the user 120 may not be able to access, modify, or write, from the client device 110, any further data stored in the network. If the user 120 fails to re-authenticate or does not attempt to re-authenticate, the trigger event may be further investigated.

Based on results of the re-authentication, the incident management unit 330 may selectively perform the at least one mitigation action. The at least one activity may be caused by one or more of the following: malware installed on a user computer, ransomware, intentional behavior by an employee (e.g., unauthorized copying or deleting files), an employee being an intentional insider threat, an employee being a data thief, and the like. In an example embodiment, the at least one mitigating action in response to the at least one activity may include one or more of the following: forcing the re-authentication, forcing to re-authenticate within a predetermined time window, blocking the credentialed access, suspending the credentialed access, creating an escalation request for a further investigation, sending an alert to a security officer associated with the network, and so forth.

In an example embodiment, the at least one trigger event and the at least one mitigating action may be configured via a User Interface (UI) by a representative of an organization associated with the network.

In an example embodiment, the real-time assessing unit 320 and the long-term assessing unit 350 may be configured to save activity data associated with the at least one activity of the user 120 to a database. The activity data may include the at least one activity during a time period associated with the at least one trigger event. Upon request, the real-time assessing unit 320 and the long-term assessing unit 350 may issue a report visualizing the data. The report may be requested, for example, by the representative of the organization associated with the network. For example, to ensure an adversary is not re-authenticating and covering the intrusion tracks, an activity summary may be sent at a random time later showing what trigger event occurred and what files were being accessed during the time period of the trigger event.

In some embodiments, the report may be provided to the user. The user may review the report and determine whether all actions in the report were performed by the user. If the user detects some actions performed not by the user, the user may notify the security officer that an adversary has performed some actions using the credentialed access granted to the user.

Moreover, both the real-time assessing unit 320 and the long-term assessing unit 350 may be configured to analyze the activity data for access patterns and threat signatures. Based on the analysis performed by the real-time assessing unit 320 and/or the long-term assessing unit 350, the incident management unit 330 may selectively perform the at least one mitigating action.

The trigger event can be further investigated when the user does not successfully re-authenticate within a specific period of time. Specifically, an investigation by a security operations center (SOC) associated with the system 300 may be triggered.

In an example embodiment, an external entity 415 may additionally monitor the activity in the network. The external entity 415 may include, for example, security information and event management (SIEM), a SOAR tool, a security response tool, a management tool, and the like. The external entity 415 may analyze the activity and identify suspicious actions. The suspicious actions may include weak or compromised passwords used by the user in other systems, attacks happening in systems connected to the same network environment, and the like. The external entity 415 may send an alarm to the system 300. In response to the alarm, the system 300 may initiate the re-authorization of users.

FIG. 5 is a flow chart showing a method 500 for trust evaluation of network activities, according to an example embodiment. The method 500 can be implemented by using the system 300 shown in FIG. 1 and FIG. 3 and the client device 120 shown in FIG. 1 and FIG. 2. In some embodiments, the operations of method 500 may be combined, performed in parallel, or performed in a different order. The method 500 may also include additional or fewer operations than those illustrated.

The method 500 may commence in block 505 with receiving, from a user, a request to access at least one file on a network. The request may be associated with a user account of the user or an IP address of the client device of the user.

In block 510, the method 500 may include authenticating the user using a multi-factor authentication method. In block 515, the method 500 may include selectively granting, based on the authentication, the user a credentialed access to the at least one file. In some example embodiments, the credentialed access may be associated with one or more of the following: a user account, an IP address, a group of users associated with the IP address, and so forth.

The method 500 may further include analyzing, based on a security policy, at least one activity of the user in block 520. The at least one activity may be analyzed to determine whether the at least one activity is caused by one or more of the following: malware installed on a user computer, ransomware, intentional behavior by an employee, an intentional insider threat, a data theft, and so forth.

The security policy may include at least one trigger event and at least one mitigating action. The at least one trigger event and the at least one mitigating action may be configured via an UI by a representative of an organization associated with the network.

The method 500 may continue with determining, based on the analysis, that the at least one trigger event has occurred. In response to determining that the at least one trigger event has occurred, a re-authentication of the user may be triggered, as shown in block 525. In some embodiments, the at least one trigger event may include one or more of the following: an access to share from a new IP address by the user, an access to a folder a first time and after a time period by the user, an access outside of defined normal working hours, a mass delete, a mass read, a mass copy, a total number of files accessed by the user, a file extension rename, an access to a designated sensitive folder, an access to a designated sensitive folder after the time period, an access to a designated sensitive file, an access by an administrative user, an access by an administrative group, a simultaneous access from multiple IP addresses with the same user account, an access to file shares for the first time after a defined period of inactivity, an excessive number of incorrectly entered passwords, and the like.

The triggering of the re-authentication may include one or more of the following: a request to a data storage through an API to force the re-authentication, performing the re-authentication of users associated with an organization after a defined period at random, and so forth.

The re-authentication may be performed according to a predetermined re-authentication protocol. The predetermined re-authentication protocol may include one or more self-service user actions performed within a time window. The self-service user actions may include one or more of the following: responding to an SMS push notification, confirming information, identifying files recently accessed from a list shown to the user, responding to an email challenge question, responding to a web link challenge question, and the like. In further example embodiments, the predetermined re-authentication protocol may include one or more third party actions. The one or more third party actions may include requiring the user to record an audio or a video with a random phrase within a time period, the audio or the video being reviewed by a third party for correctness; matching a user video with a picture; forcing a challenge through a third party enterprise identity management system; and the like.

The method 500 may further include selectively performing the at least one mitigating action based on results of the re-authentication, as shown in block 530. In some example embodiments, the at least one mitigating action may include one or more of the following: forcing the re-authentication, blocking the credentialed access, suspending the credentialed access, creating an escalation request for a further investigation, and the like.

The method 500 may optionally include saving activity data associated with the at least one activity to a database. The activity data may include the at least one activity during a time period associated with the at least one trigger event. Upon request, a report visualizing the data may be issued. The method 500 may further optionally include analyzing the activity data for access patterns and threat signatures. Based on the analysis, the at least one mitigating action may be selectively performed.

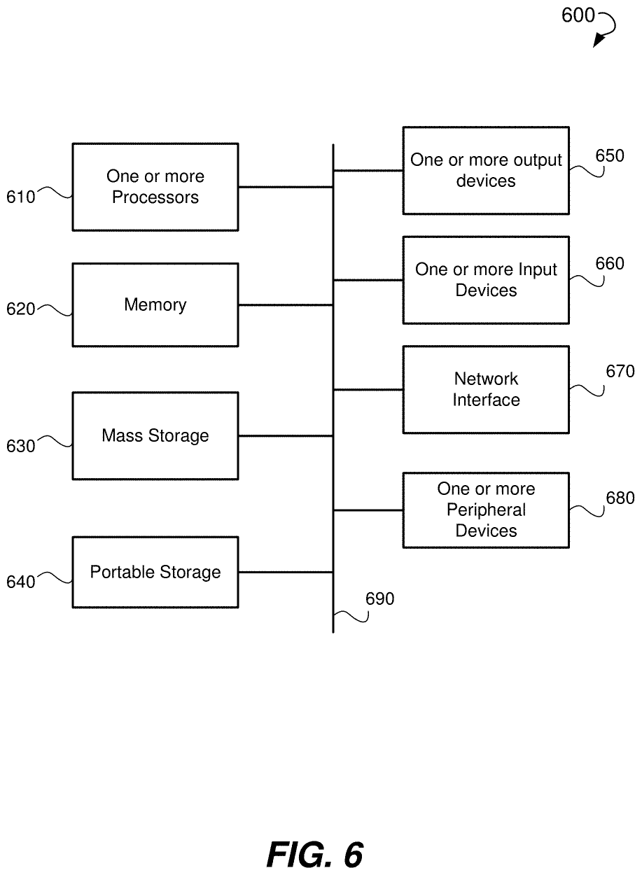

FIG. 6 illustrates an exemplary computing system 600 that may be used to implement embodiments described herein. The computing system 600 can be implemented in the contexts of the client device 110, the system 300, and units 310-350 of the system 300. The exemplary computing system 600 of FIG. 6 may include one or more processors 610 and memory 620. Memory 620 may store, in part, instructions and data for execution by the one or more processors 610. Memory 620 can store the executable code when the exemplary computing system 600 is in operation. The exemplary computing system 600 of FIG. 6 may further include a mass storage 630, portable storage 640, one or more output devices 650, one or more input devices 660, a network interface 670, and one or more peripheral devices 680.

The components shown in FIG. 6 are depicted as being connected via a single bus 690. The components may be connected through one or more data transport means. The one or more processors 610 and memory 620 may be connected via a local microprocessor bus, and the mass storage 630, one or more peripheral devices 680, portable storage 640, and network interface 670 may be connected via one or more input/output buses.

Mass storage 630, which may be implemented with a magnetic disk drive, an optical disk drive, or a solid state disk drive, e.g., with a NAND flash, is a non-volatile storage device for storing data and instructions for use by a magnetic disk or an optical disk drive, which in turn may be used by one or more processors 610. Mass storage 630 can store the system software for implementing embodiments described herein for purposes of loading that software into memory 620.

Portable storage 640 may operate in conjunction with a portable non-volatile storage medium, such as a compact disk (CD) or digital video disc (DVD), to input and output data and code to and from the computing system 600 of FIG. 6. The system software for implementing embodiments described herein may be stored on such a portable medium and input to the computing system 600 via the portable storage 640.

One or more input devices 660 provide a portion of a UI. The one or more input devices 660 may include an alphanumeric keypad, such as a keyboard, for inputting alphanumeric and other information, or a pointing device, such as a mouse, a trackball, a stylus, or cursor direction keys. Additionally, the computing system 600 as shown in FIG. 6 includes one or more output devices 650. Suitable one or more output devices 650 include speakers, printers, network interfaces, and monitors.

Network interface 670 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 670 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 680 may include any type of computer support device to add additional functionality to the computing system. The one or more peripheral devices 680 may include a modem or a router.

The components contained in the exemplary computing system 600 of FIG. 6 are those typically found in computing systems that may be suitable for use with embodiments described herein and are intended to represent a broad category of such computer components that are well known in the art. Thus, the exemplary computing system 600 of FIG. 6 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, methods of and systems for trust evaluation of network activities have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for trust evaluation of network activities, the method comprising:
receiving, from a user, a request to access at least one file on a network;
authenticating the user using a multi-factor authentication method;
based on the authentication, selectively granting the user a credentialed access to the at least one file;
analyzing, based on a security policy, at least one activity of the user, the security policy including at least one trigger event and at least one mitigating action;
in response to determining, based on the analysis, that the at least one trigger event has occurred, triggering a re-authentication of the user; and
based on results of the re-authentication, selectively performing the at least one mitigating action.

2. The method of claim 1, wherein the request is associated with one or more of the following: a user account and a client machine Internet Protocol (IP) address.

3. The method of claim 1, wherein the at least one trigger event and the at least one mitigating action are configured via a User Interface (UI) by a representative of an organization associated with the network.

4. The method of claim 1, wherein the at least one mitigating action includes one or more of the following: forcing the re-authentication, blocking the credentialed access, suspending the credentialed access, and creating an escalation request for a further investigation.

5. The method of claim 1, wherein the credentialed access is associated with one or more of the following: a user account, an IP address, and a group of users associated with the IP address.

6. The method of claim 1, wherein the at least one trigger event includes one or more of the following: an access to share from a new IP address by the user, an access to a folder a first time and after a time period by the user, an access outside of defined normal working hours, a mass delete, a mass read, a mass copy, a total number of files accessed by the user, a file extension rename, an access to a designated sensitive folder, an access to a designated sensitive folder after the time period, an access to a designated sensitive file, an access by an administrative user, an access by an administrative group, a simultaneous access from multiple client devices with the same user account, an access to file shares for the first time after a defined period of inactivity, and an excessive number of incorrectly entered passwords.

7. The method of claim 1, wherein the triggering of the re-authentication includes one or more of the following: a request to a data storage through an Application Programming Interface (API) to force the re-authentication and performing the re-authentication of users associated with an organization after a defined period at random.

8. The method of claim 1, wherein the re-authentication is performed according to a predetermined re-authentication protocol, wherein the predetermined re-authentication protocol includes one or more self-service user actions performed within a time window, the self-service user actions including one or more of the following: responding to an SMS push notification, confirming information, identifying files recently accessed from a list shown to the user, responding to an email challenge question, and responding to a web link challenge question.

9. The method of claim 1, wherein the re-authentication is performed according to a predetermined re-authentication protocol, wherein the predetermined re-authentication protocol includes one or more of third party actions: requiring the user to record an audio or a video with a random phrase within a time period, the audio or the video being reviewed by a third party for correctness, matching a user video with a picture, and forcing a challenge through a third party enterprise identity management system.

10. The method of claim 1, further comprising:
saving activity data associated with the at least one activity to a database, the activity data including the at least one activity during a time period associated with the at least one trigger event; and
upon request, issuing a report visualizing the data.

11. The method of claim 9, further comprising:
analyzing the activity data for access patterns and threat signatures; and
based on the analysis, selectively performing the at least one mitigating action.

12. The method of claim 1, wherein the at least one activity is caused by one or more of the following: malware installed on a user computer, ransomware, intentional behavior by an employee, an intentional insider threat, and a data theft.

13. A system for trust evaluation of network activities, the system comprising:
an active defense unit configured to:
receive, from a user, a request to access at least one file on a network;
authenticate the user using a multi-factor authentication method; and
based on the authentication, selectively grant the user a credentialed access to the at least one file;
a real-time assessing unit configured to:
analyze, based on a security policy, at least one activity of the user, the security policy including at least one trigger event and at least one mitigating action;
an identity management unit configured to:
in response to determining, based on the analysis, that the at least one trigger event has occurred, triggering a re-authentication of the user; and
an incident management unit configured to:
based on results of the re-authentication, selectively performing the at least one mitigation action.

14. The system of claim 13, wherein the at least one trigger event includes one or more of the following: an access to share from a new IP address by the user, an access to a folder a first time and after a time period by the user, an access outside of defined normal working hours, a mass delete, a mass read, a mass copy, a total number of files accessed by the user, a file extension rename, an access to a designated sensitive folder, an access to a designated sensitive folder after the time period, an access to a designated sensitive file, an access by an administrative user, an access by an administrative group, a simultaneous access from multiple client devices with the same user account, an access to file shares for the first time after a defined period of inactivity, and an excessive number of incorrectly entered passwords.

15. The system of claim 13, wherein the triggering of the re-authentication includes one or more of the following: a request to a data storage through an Application Programming Interface (API) to force the re-authentication and performing the re-authentication of users associated with an organization after a defined period at random.

16. The system of claim 13, wherein the re-authentication is performed according to a predetermined re-authentication protocol, wherein the predetermined re-authentication protocol includes one or more self-service user actions performed within a time window, the self-service user actions including one or more of the following: responding to an SMS push notification, confirming information, identifying files recently accessed from a list shown to the user, responding to an email challenge question, and responding to a web link challenge question.

17. The system of claim 13, wherein the re-authentication is performed according to a predetermined re-authentication protocol, wherein the predetermined re-authentication protocol includes one or more of third party actions: requiring the user to record an audio or a video with a random phrase within a time period, the audio or the video being reviewed by a third party for correctness, matching a user video with a picture, and forcing a challenge through a third party enterprise identity management system.

18. The system of claim 13, wherein the real-time assessing unit is further configured to:
save activity data associated with the at least one activity to a database, the activity data including the at least one activity during a time period associated with the at least one trigger event; and
upon the request, issue a report visualizing the data.

19. The system of claim 18, wherein the real-time assessing unit is further configured to:
analyze the activity data for access patterns and threat signatures; and
the incident management unit is further configured to:
based on the analysis, selectively perform the at least one mitigating action.

20. A system for trust evaluation of network activities, the system comprising:
an active defense unit configured to:
receive, from a user, a request to access at least one file on a network;
authenticate the user using a multi-factor authentication method;
based on the authentication, selectively grant the user a credentialed access to the at least one file;
a real-time assessing unit configured to:
analyze, based on a security policy, at least one activity of the user, the security policy including at least one trigger event and at least one mitigating action; and
an incident management unit configured to:
in response to determining, based on the analysis, that the at least one trigger event has occurred, triggering a re-authentication of the user, wherein the re-authentication is performed according to a predetermined re-authentication protocol, wherein the predetermined re-authentication protocol includes one or more of self-service user actions and third party actions, wherein the triggering of the re-authentication includes one or more of the following: a request to a data storage through an Application Programming Interface (API) to force the re-authentication and performing the re-authentication of users associated with an organization after a defined period at random; and
based on results of the re-authentication, selectively performing the at least one mitigation action.
